(19) United States
(12) Patent Application Publication
(10) Pub. No.: US 2009/0301468 A1
(43) Pub. Date: Dec. 10, 2009

(54) Thermal Storage Tank for a Hot Water System and Controlling Method Thereof

(75) Inventors: Richard Landry Gray, Saratoga, CA (US); Daniel Patrick Mckinley, Los Altos, CA (US)

Correspondence Address: Richard Landry Gray, 18900 Aspesi Drive, Saratoga, CA, 95070, US

(73) Assignee: Richard Landry Gray, Saratoga, CA (US)

(21) Appl. No.: 12/472,377

(22) Filed: May 27, 2009

Related U.S. Application Data
(60) Provisional application No. 61/130,830, filed on Jun. 4, 2008.

(51) Int. Cl. F24J 2/04; F24H 1/18; G05B 15/00

(52) U.S. Cl. 126/640; 392/441; 700/275

(57) ABSTRACT

A controlling method for a hot water system and a thermal storage tank for a hot water system are provided in the present invention. The method includes the steps of: (a) turning on the pump to circulate the first fluid and to provide the heat collector with the first fluid; (b) turning off the pump after the pump is on for a first predetermined time to hold the first fluid in the heat collector; (c) turning on the pump after the pump is off for a second predetermined time to circulate the first fluid again; and (d) returning to the step (b). The thermal storage tank holding a first fluid and comprising: a first inlet inputting the first fluid; a first outlet outputting the first fluid; a first inner tank holding a second fluid, exchanging a heat between the first fluid and the second fluid and having a second inlet and a second outlet; and a second inner tank having a first heater heating the first fluid, a third inlet connected to the first outlet and a third outlet outputting the heated first fluid.

### FIELD OF THE INVENTION

The present invention relates to a thermal storage tank and a controlling method of a hot water system. More particularly, it relates to a thermal storage tank having inner tanks and heater, and a controlling method for saving energy.

### BACKGROUND OF THE INVENTION

The inherent high efficiency of solar water heaters has the potential to save large energy costs for homeowners or commercial users. The efficiency of solar water heaters (energy input from the sun divided by increase in energy of the stored hot water) can be two to three times the efficiency of solar photovoltaic panels. Most solar water heating schemes are fairly low tech compared to solar photovoltaic systems so that the capital cost of a solar hot water system is much lower than the cost of a comparable solar photovoltaic system. This means that the return on investment (ROI) can be several times faster than the ROI for photovoltaic systems. Even so, compared to the capital costs for traditional fossil fuel burning hot water systems, a solar hot water system can be perceived as more expensive. Moreover, depending on the particular type of system, a solar hot water system may require more space as well as extra plumbing and hardware, all of which add to the cost of the system and impact the reliability as well.

Any practical solar water heater will have to be able to protect itself in all types of weather. This primarily means protection against freezing and destructively high temperatures. One day of freezing temperatures could destroy a solar hot water system and waste many thousands of dollars as the freezing water expands and breaks the pipes and pipe fittings used in the system.

There are numerous schemes for protecting solar hot water systems against freezing. Some schemes use a heat transfer medium that remains in its liquid state for temperatures where water would normally freeze. Another scheme involves actually adding heat to the heat transfer water during freezing conditions; the inefficiency of this system is readily apparent. In this invention disclosure we deal primarily with solar hot water systems known as the “drain-back” type. In a drain-back solar hot water system the heat transfer medium, usually water, is only circulated in the solar collectors when the temperature at the collector is hotter than the temperature of the water in a storage tank. When there is no useful energy to be collected from the solar panel (or if the temperature is too hot or too cold) then the heat transfer medium “drains back” into an insulated vessel until there is useful heat to be gleaned from the solar collector and the solar transfer medium is once again pumped up into the solar collectors.

The drain-back system, since it requires a pump, is known as an “active system”. A “passive” system does not require a pump and most often relies on the thermo-siphon effect to move water from the solar collector area to the heat storage area. In a passive system the heated water is slightly less dense than the colder water near it. This heated water will rise to the top of a passive system's heat storage area. This makes it necessary for the heat storage vessel to be located on top of the solar collection device, a requirement that rules out passive systems in many applications. Active systems tend to have higher thermal efficiencies than passive systems; however on the other hand, they are more complicated, perhaps more expensive and may require more maintenance.

A typical active drain back solar water heating system requires a solar collecting device such as a flat plate collector; a drain back tank; a heat exchanger (usually part of the drain back tank); a pump to circulate the heat transfer fluid through the solar collecting device and into the drain-back tank; a hot water storage tank; a pump to move the water through the heat exchanger and back into the storage tank, and a controller that senses the temperature at the solar collector and the temperature at the coldest point of the storage tank. When the temperature at the solar collector is warmer than the temperature at the coldest part of the storage tank both pumps are turned on and heat is moved from the solar collector into the heat exchanger and then from the heat exchanger into the solar storage tank until the temperature in the storage tank is within some preset temperature of the solar collector. If the temperature is too cold the pumps never turn on and the water in the drain back tank stays safely inside it. If the temperature at the solar collector is too hot the pumps never turn on and the water in the drain back tank again stays safely inside the drain back tank. See FIGS. 1 and 2 for various prior art drain back systems. The solar water heating systems 100 and 200 respectively have a solar collecting device 1001, a first pump 1002, a drain back tank heat exchanger 1003, a second pump 1004 and a standard electric/gas water heater 1005, but the system 200 has a solar hot water storage 2001 as well. [the system 100 has no solar hot water storage, but system 200 has one.]

The drain-back system just described gives excellent freeze protection and high temperature protection. The electrical energy required to drive the two pumps is usually justified by the high efficiency of this system over passive solar hot water systems. While this type of drain-back system is very serviceable, it suffers from several drawbacks: (1) Too complex—two pumps, a separate tank from the hot water storage tank, extra piping. (2) Takes up too much room—the drain back tanks require space that may not be available near the hot water storage tank. (3) Extra plumbing decreases efficiency—even with careful pipe/tank insulation the drain back tank and associated plumbing are constantly leaking heat into the environment, causing the efficiency of the system to degrade. (4) Too expensive—the drain back tank, pumps and controller form a significant cost beyond the cost of the solar collection devices and certainly beyond the cost of a traditional fossil fuel burning hot water heating device. (5) Too much electrical energy needed—the thermal transfer fluid must be continually lifted up to the solar collecting panel when there is useful energy to be harvested from the panels.

Therefore, it would be useful to invent a thermal storage tank and a controlling method of a hot water system to circumvent all the above issues. In order to fulfill this need the inventors have proposed an invention: “THERMAL STORAGE TANK FOR A HOT WATER SYSTEM AND CONTROLLING METHOD THEREOF.” The summary of the present invention is described as follows.

### SUMMARY OF THE INVENTION

The object of the present invention is to provide a thermal storage tank having inner tanks and heater, and a controlling method for saving energy. According to the first aspect of the present invention, a solar hot water system includes: a thermal storage tank holding a first fluid; a pump circulating a second fluid to flow through a second outlet and to a second inlet; and a solar collector panel absorbing a solar energy to provide at least a portion of the heat to the second fluid. The thermal storage tank includes: a first inlet inputting the first fluid; a first outlet outputting the first fluid; a first inner tank holding the second fluid which exchanges (a) heat between the first fluid and the second fluid and which has the second inlet and the second outlet; and a second inner tank having a first heater to heat the first fluid, a third inlet connected to the first outlet and a third outlet outputting the heated first fluid.

Preferably the solar hot water system further includes a first temperature sensor detecting a first temperature of the first inner tank, a second temperature sensor detecting a second temperature of the solar collector panel and a pump controller controlling the pump according to the first and the second temperatures.

Preferably the solar hot water system further includes a first pipe connected to the third inlet and the first outlet, a second pipe connected to the pump and the second outlet and a third pipe connected to the pump and the second inlet, wherein the first fluid is provided by an external source, the third pipe has a specific portion configured in the solar collector panel, the first heater is an electrical heating element, the thermal storage tank is an insulating tank, and each of the thermal storage tank, the first inner tank and the second inner tank has a bottom and a top.

Preferably in this solar hot water system the first inlet and the first outlet are respectively positioned near the bottom and the top of the thermal storage tank; the second inlet and the second outlet are respectively positioned near the top and the bottom of the first inner tank; and the third inlet and the third outlet are respectively positioned near the bottom and the top of the second inner tank.

Preferably in this solar hot water system the thermal storage tank further includes at least one sacrificial anode to retard corrosion and a second heater heating the first fluid; the second inner tank is inside the first inner tank.

Preferably this solar hot water system further includes a first heater controller having a third temperature sensor, which adjusts an electrical current of the electrical heating element and which regulates a third temperature of the heated first fluid.

Preferably in this solar hot water system the third pipe contains a valve and holds the second fluid in the specific portion of the third pipe.

Preferably in this solar hot water system the thermal storage tank is a standard gas fired hot water heater which is free from a burner and a temperature controller, and the standard gas fired hot water heater has a sealed top and a sealed bottom.

According to the second aspect of the present invention, a hot water system includes a thermal storage tank holding a first fluid. The thermal storage tank includes: a first inlet inputting the first fluid; a first outlet outputting the first fluid; and a first inner tank having a first heater heating the first fluid, a second inlet connected to the first outlet and a second outlet outputting the heated first fluid.

Preferably in this hot water system the thermal storage tank further includes a second inner tank holding a second fluid, exchanging a heat between the first fluid and the second fluid, and having a third inlet and a third outlet.

Preferably this solar hot water system further includes: a first pipe connecting the second inlet and the first outlet; a pump circulating the second fluid; a second pipe connecting the pump and the third outlet; a heat collecting device; a third pipe connecting the pump and the heat collecting device; and a fourth pipe connecting the third inlet and the heat collector device.

Preferably in this hot water system the thermal storage tank is a standard gas fired hot water heater which is free from a burner and a temperature controller, and the standard gas fired hot water heater has a sealed top and a sealed bottom.

Preferably in this hot water system the second inner tank has a specific configuration which is one of a configuration partially enclosed in the first inner tank and a configuration fully enclosed in the first inner tank.

According to the third aspect of the present invention, a method for controlling a hot water system having a pump, a heat collector and a first fluid includes: the steps of (a) turning on the pump to circulate the first fluid and to provide the heat collector with the first fluid; (b) turning off the pump after the pump is on for a first predetermined time to hold the first fluid in the heat collector; (c) turning on the pump after the pump is off for a second predetermined time to circulate the first fluid again; and (d) returning to the step (b).

Preferably the method is provided by which the step (a) further includes the steps of: (a1) turning on the pump when a first temperature of the heat collector is between a first predetermined temperature and a second predetermined temperature; and (a2) turning off the pump when the first temperature is out of a range between the first predetermined temperature and the second predetermined temperature.

Preferably the method is provided, in which the step (c) further includes a step (c1) of turning off the pump when the first temperature is out of the range between the first predetermined temperature and the second predetermined temperature.

Preferably the method is provided in which the system further includes a heat exchanging tank; the first fluid is circulated between the heat exchanging tank and the heat collector, and the second predetermined temperature is above the first predetermined temperature.

Preferably the method is provided by which the first predetermined temperature is above a second temperature of the heat exchanging tank.

Preferably, the method is provided in which the step (a) further includes a step (a3) of turning off the pump when the first temperature is below a second temperature of the heat exchanging tank, and the step (c) further includes a step (c2) of turning off the pump when the first temperature is below the second temperature of the heat exchanging tank.

Preferably the method is provided in which the step (a2) further includes a step of (a21) which drains all the first fluid back to the heat exchanging tank when the pump is turned off and the step (c1) further includes a step of (c11) which drains all the first fluid back to the heat exchanging tank when the pump is turned off.

Preferably the method is provided in which the step (b) further includes a step (b1) of turning off the pump when the heat collector is filled up with the first fluid.

Preferably the method is provided in which the step (c) further includes a step (c1) of turning on the pump when a third temperature of the first fluid in the heat collector reaches a third predetermined temperature.

The above objects and advantages of the present invention will become more readily apparent to those ordinarily skilled in the art after reviewing the following detailed descriptions and accompanying drawings in which:

### BRIEF DESCRIPTION OF THE DRAWINGS

FIG. 1 shows a first prior art drain back system;

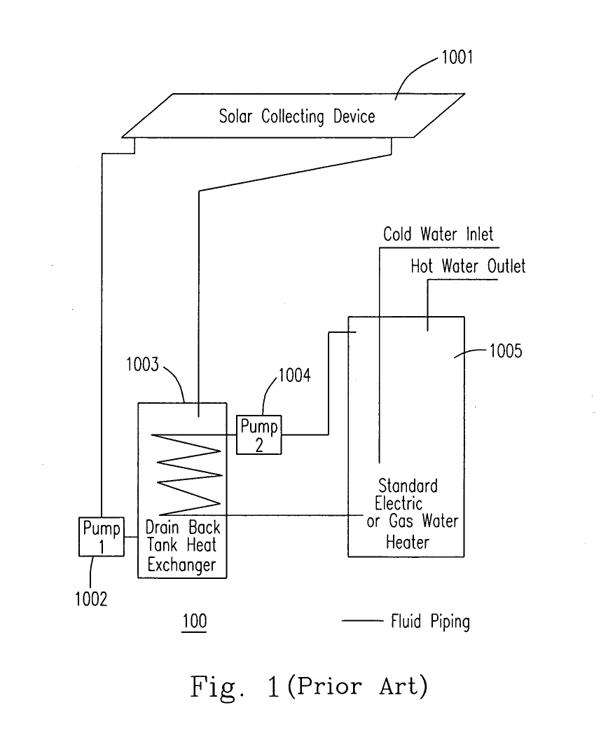

FIG. 2 shows a second prior art drain back system;

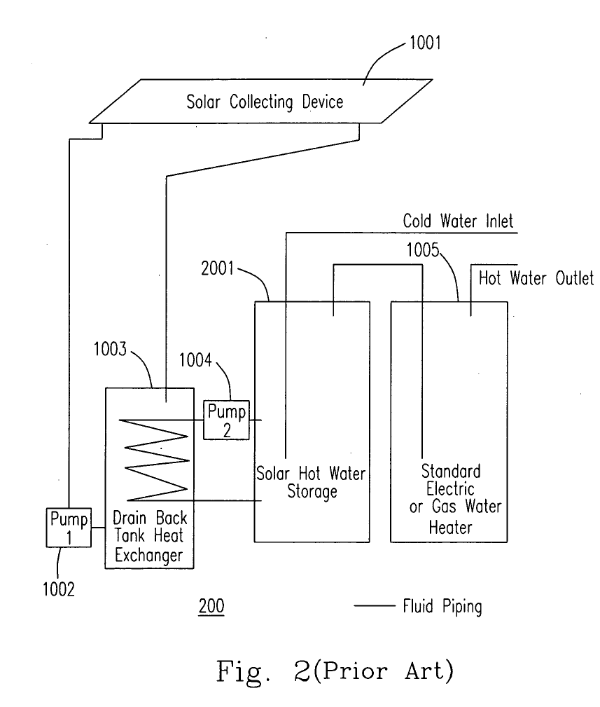

FIG. 3a shows a first preferred embodiment of the invention;

FIG. 3b shows the A-A′ section of the first preferred embodiment;

FIG. 4 shows a first method for controlling a hot water system; and

FIG. 5 shows a second preferred embodiment of the present invention.

### DETAILED DESCRIPTION OF THE PREFERRED EMBODIMENT

Differing from the various prior art listed at the beginning of this description the current invention places the drain-back tank, the heat exchanger, and storage tank within one vessel. Only one pump is necessary. The external plumbing is minimized because there is now no need to pump water through the heat exchanger and into the storage tank. Since the drain-back tank is almost totally enclosed by the storage tank, the heat that would normally leak out of the drain back tank into the ambient atmosphere instead leaks into the storage tank, which is the ideal situation.

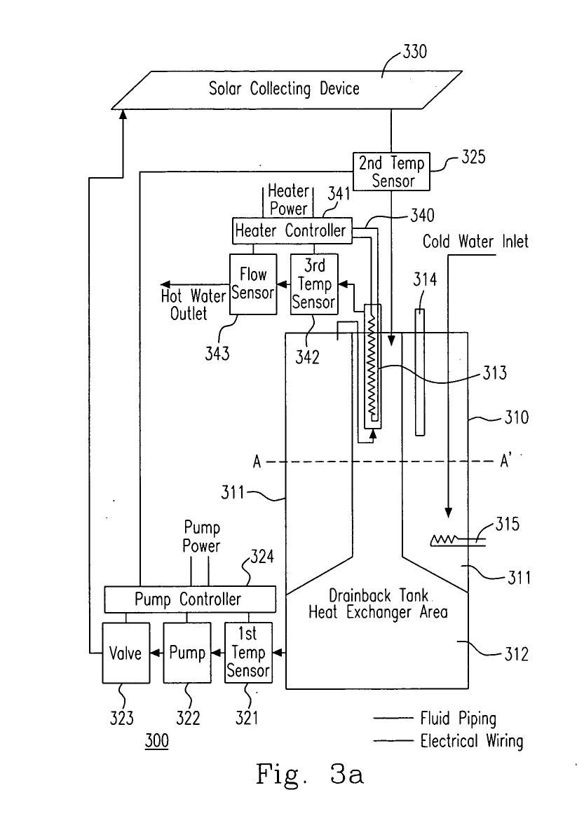

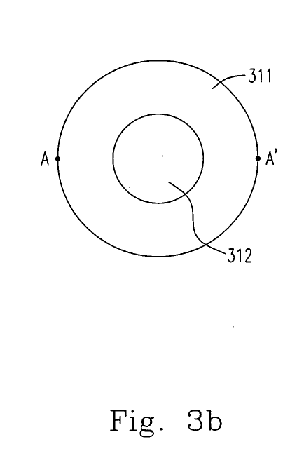

Please refer to FIG. 3a which shows a first preferred embodiment of the invention and FIG. 3b which shows A-A′ section of the first preferred embodiment. A solar hot water system 100 includes a solar thermal storage tank 310, a first temperature sensor 321, a pump 322, a valve 323, a pump controller 324, a second temperature sensor 325 and a solar collecting device 330. The invention includes the solar thermal storage tank 310 which has a storage tank 311 for cold water inlet, a drain-back tank 312 with heat exchanging function and an output tank 313 which connects the storage tank 311 by fluid piping for hot water outlet. The fluid in the drain-back tank 312 (as transfer medium) is circulated by the pump 322 through the first temperature sensor 321, the pump 322, the valve 323, the solar collecting device 330 and the second temperature sensor 325(sensing the temperature of the fluid from the solar collecting device 330). The pump controller 324 is electrically coupled to the first temperature sensor 321, the pump 322, the valve 323 and the second temperature sensor 325. The output tank 313 has an on-demand heater 340, and the on-demand heater 340 can be further controlled by a heater controller 341. In order to detect the status of the output tank 313, the heater controller 341 is further coupled to a third temperature sensor 342 and a flow sensor 343 by electrical wiring. The flow sensor 343 must be coupled to the output tank 313 by fluid piping. Furthermore, the solar storage tank 310 can include a sacrificial anode 314 and a pre-heater element 315. The solar collecting device 300 can further include a pipe or other space for holding a fluid by which the fluid can be circulated through the solar collecting device 300 and the drain-back tank 312 (as a heat exchanging tank).

The output tank 313 with an electric on-demand water heater 340 can boost the temperature of the water up to its desired value in the case in which the solar heated water does not reach the desired temperature. The location of output tank 313 with the on-demand water heater 340 in the drain-back tank 312 means that any waste heat from the on-demand heater 340 is used to preheat the water in the drain-back tank 312 and thus is not wasted. The prior arts have used electric elements to heat most of the water in the storage tank up to the desired user temperature (approx 120 F to 140). This is non-optimal in that the large volume of electrically heated water is now dissipating its heat to the environment and defeating the purpose of a solar water heating system. It is advantageous to allow the sun to heat the water in the thermal storage tank 310 as much as possible; if the water temperature (sensed by the first temperature sensor 321) is still lower than desired; only the water exiting the hot water system is heated up to the user's desired temperature, not the whole volume of water in the tank. Note that the output tank 313 can also be put in the storage tank 311 or in the thermal storage tank 310 (or partially in the thermal storage tank 310).

The invention, excluding the solar collectors mounted on the roof, can be realized within the volume of an existing water heater. In fact it is the intention of this invention that it could be used to replace existing fossil fuel hot water heaters. The only added plumbing required would be the pipes connecting the solar collecting devices to the invention (and the solar collecting panels, of course).

Prior art control systems detect the temperature at the solar collecting panel and compare it to the temperature of the water at the lowest point in the storage tank. When the panel temperature is sufficiently hotter than the storage tank temperature the pumps are turned on and water is circulated from the drain back tank up though the solar collecting panels. The pumps (or pump) stay on until the temperature difference between the panel and the storage tank has fallen to some smaller value than the value that initiated the pumps to turn on. The problem with this existing control scheme is that the pumps remain on for a very long time, requiring enough electrical energy to lift the water from the drain-back tank up through the solar panels.

The invention described here uses a modified control algorithm. In the first preferred embodiment, the pump 322 is still turned on when the solar collecting device 330 to the drain-back tank 312 (or the storage tank 311) temperature difference reaches a certain value. However, in this case the pump 322 only operates long enough to ensure that the solar collecting device 330 has filled up with water. Then an electrically operated valve 323 near the pump 322 closes, and the pump 322 is turned off. The water remains in the solar collecting device 330 getting warmer and warmer. After a certain time has elapsed (or the water in the device has reached a certain temperature) the valve 323 opens allowing the recently heated water in the solar collecting device 330 to flow down into the drain-back tank 312 where its heat is transferred to the water in the storage tank 311. The cycle repeats when the solar collecting device 330 temperature is still larger than the drain-back tank 312 (or the storage tank 311) temperature by the required amount. Note that the solar collecting device 330 could be a solar collecting panel set.

In a typical household (in which people are at school or work during the day) most of the hot water usage will be in the morning or evening when the sun is not present. The household will be dependent on the amount of solar energy stored in the tank from the previous solar day's heating. There is a limit to the amount of energy that can be stored in the storage tank. The stored energy is a function of the volume of water in the storage tank and the average temperature of the water. The volume is restricted by economics and space. Solar storage tanks are readily available up to 80 gallons, but they are much rarer and more expensive for capacities in excess of 80 gallons. Also very few households would be able to find the room for a very large solar storage tank or be able to pay for one. The maximum temperature in the storage tank at the end of a solar day is really a function of the weather (plus the basic design of the solar collector) and less dependent on the volume of thermal transfer fluid pumped through the solar panel. Since the solar collecting day is many hours long and the solar energy storage device is limited in capacity, there is little reason to expend much electrical energy pumping large amounts of thermal transfer water through the solar panels and into the heat exchanger. In other words, for most modest sized solar water applications it would be more efficient to slowly heat the water in the storage tank using a minimum of electrical power to pump the thermal transfer medium.

It is important that the electrically operated valve 323 used to hold the water in the solar collecting device 330 would default to the open state when power is removed from the pump controller 324. In this way during a power outage the default state will allow the water that may have been in the solar collecting device 330 to drain back safely into the drain-back tank 312 where it is safe from freezing and overheating.

Perhaps an even more important fact of this invention is that it can be realized by modifying an existing natural gas or propane water heater in order to form the basic hot water storage and drain back tank unit. Because of the ready availability of fossil fuel burning hot water heaters and their low cost (by volume manufacturing) the possibility of providing solar hot water systems at a cost on the order of a conventional fossil fuel hot water system (neglecting the cost of the solar collecting devices, which would be a fixed cost in any solar hot water system) could be realized. Since gas hot water heaters are already manufactured in very high volume the cost of the basic system could be very low.

Modifying existing gas water heaters to emulate the proposed invention involves using the combustion chamber and exhaust gas flue as the drain-back tank and the heat exchanger. The bottom of the combustion chamber is closed off with a water tight seal (most likely by welding a steel plate to the bottom of the combustion chamber) after the existing burners and burner control hardware have been removed. The steel combustion chamber and steel flue provide a large surface area of contact between the storage tank and the drain-back tank, facilitating heat transfer from the heat transfer fluid into the water in the storage tank. Copper is usually desirable for heat exchanger applications such as this one. However, the large inherent surface area of the steel interface between the storage tank area and the drain-back tank provides excellent heat transfer properties at a fraction of the cost of a similar copper heat exchanger. Making most of the components out of the same material (steel in this case) will also minimize galvanic corrosion due to the use of dissimilar metals.

Conventional fossil fuel burning hot water tanks with large bore flues are preferable because a larger amount of heat transfer liquid (water) will be available in the drain-back tank. This is desirable to make enough heat transfer fluid (water) available to fill up the solar collecting devices when the pump is turned on, leaving enough fluid at the bottom of the drain-back tank to provide good thermal transfer from the heat transfer fluid into the storage tank liquid.

A port must be added in the bottom of the drain-back area (old combustion area) so that a pump can move the heat transfer fluid from the drain-back tank up to the solar collecting device and back down; in this way the heat can be harvested from the solar collecting device and eventually be stored in the storage tank. Return water from the solar collecting device can drain back into what was the original flue. A sacrificial anode should be added to the drain-back tank to retard corrosion of the steel lining the drain-back area. The storage tank already has one or more sacrificial anodes; it may also already be lined with a corrosion inhibiting layer. An added manufacturing step could add the corrosion inhibiting layer to the inside of the combustion area and flue, although this is not the practice in gas water heater construction at this time. The reason for this is that the high heat available in the combustion area would damage most reasonably priced corrosion inhibiting layers. However, the metals used in the combustion chamber are already somewhat corrosion resistant; otherwise the high heat and oxidizing atmosphere would degrade the combustion area prematurely. Note that each tank may have its own sacrificial anodes to prevent the corrosion.

The on-demand water heater is placed in the top of the original flue. The level of drain-back water may rise above the on-demand heater since the on-demand heater must be completely waterproof in order to work properly. Preheated water from the top of the storage tank is used as the inlet water to the on-demand heater. The preheated water moves across a heating coil and is further heated until it exits the top of the on-demand heater. In the first preferred embodiment the third temperature sensor 342 (or a thermostat) senses the output temperature of the on-demand heater 430 (or the fluid in the output tank 313) and turns the heating coil on or off in order to maintain the desired temperature of the output water. The flow sensor 343 prevents the heating coil from being activated unless water is flowing across it.

Although modifying an existing natural gas or propane water heater will be an extremely cost effective and efficient means to implementing this invention, it is by no means necessary to do so. This invention is not limited to a particular manufacturing means. The concept of the invention can be applied to systems constructed from basic components and manufactured strictly for the purposes of implementing the invention. The thermal storage tank of the invention could be a standard gas fired hot water heater (being free from a burner and a temperature controller). Such a standard gas fired hot water heater has a sealed top and a sealed bottom. For instance, the drain-back tank 312 could be the combustion area and flue area of a gas fired water heater.

It is quite possible that the temperature of the solar heated water may be above the desired output temperature. In that case the on demand heater will not turn on at all. As in all solar hot water systems a tempering valve must be added at the output of the system to keep the output water from reaching dangerously high temperatures.

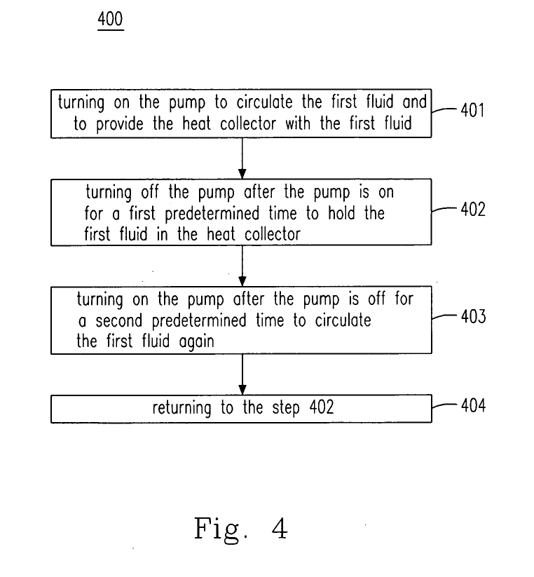

Please refer to FIG. 4 which shows a first method for controlling a hot water system. The hot water system includes a pump, a heat collector and a first fluid. The first method 400 begins with the step 401 turning on the pump to circulate the first fluid to provide the heat collector with the first fluid. The next step 402 turns off the pump after the pump is on for a first predetermined time to hold the first fluid in the heat collector. The following step 403 turns the pump on after the pump is off for a second predetermined time in order to circulate the first fluid again. The final step 404 returns to the step 402, and the cycle repeats itself. With method 400 the use of energy for the pump decreases. Note that the first predetermined time determines how much fluid is transferred into the heat collector, and the second predetermined time determines how long the fluid remains in the heat collector. The system can further include a heat exchanging tank for transferring the heat from the first fluid to a second fluid.

For cases in which 1) the heat collector is too cold to be useful for heating the fluid, or 2) it is too hot and the fluid is in danger of boiling or damaging other parts of the solar water heater, the fluid needs to be drained out of the heat collector. To attain this goal, the user can set a first predetermined temperature and a second predetermined temperature and in this way the pump is turned off if a first temperature of the heat collector is out of the range between the first predetermined temperature and the second predetermined temperature at any moment, or at some step the user desires. Furthermore, a valve or other means can be used to drain all the fluid back into the heat exchanging tank when the first temperature of the heat collector is out of the predetermined range. For this example, the second predetermined temperature is set to be greater than the first predetermined temperature. Moreover, the first predetermined temperature is above a second temperature of the heat exchanging tank, i.e. the first predetermined temperature tracks the second temperature of the heat exchanging tank so that energy flows from the heat collector into the heat exchanging tank and not vice versa. The second predetermined temperature could be some fixed value that is low enough to ensure that the solar collecting equipment and the fluid remain undamaged yet high enough to make use of most of the available solar energy.

If the first temperature of the heat collector is smaller than the second temperature of the heat exchanging tank, the system cannot heat the fluid but will instead pump heat from the exchanging tank back into the solar collector. In this situation, the pump needs to be turned off to prevent heat loss. Note that once the first temperature is greater than the second temperature and with the predetermined range, the pump could be automatically turned on for heating the fluid again. For the method 400, the step 402 can further comprise a step of turning off the pump when the heat collector is filled up with the first fluid so that the user can save some energy by eliminating unnecessary pumping. The step 403 can further comprise a step of turning on the pump when a third temperature of the first fluid in the heat collector reaches a desired temperature so that the user can heat the fluid as soon as possible.

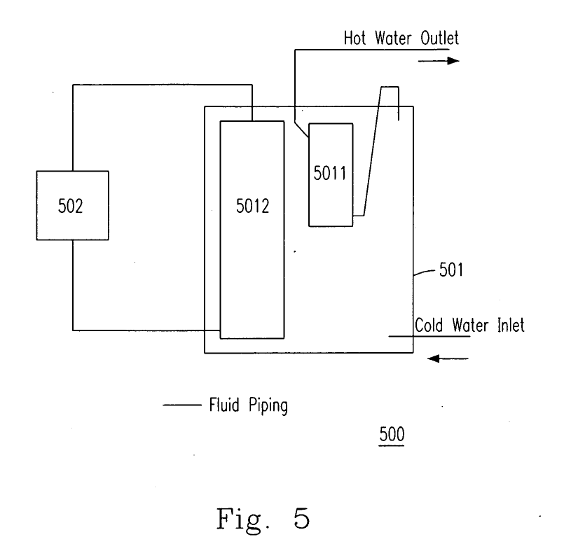

Please refer to FIG. 5 which shows a second preferred embodiment of the present invention. A hot water system 500 includes a thermal storage tank 501 and a heat collector 502. The thermal storage tank 501 includes a first inlet inputting a first fluid, a first outlet outputting the first fluid and a first inner tank 5012. The first inner tank 5011 has a heater heating the first fluid, a second inlet connected to the first outlet and a second outlet outputting the heated first fluid. The thermal storage tank 501 further includes a second inner tank 5012 holding a second fluid and coupled to the heat collector 502. The second inner tank 5012 exchanges a heat between the first fluid and the second fluid and has a third inlet and a third outlet. In order to connect these tanks and the heat collector, pipes can be used. For instance, a first pipe connects the second inlet and the first outlet, a pump circulates the second fluid, a second pipe connects the pump and the third outlet, a third pipe connects the pump and the heat collector, and a fourth pipe connects the third inlet and the heat collector. Note that the first inner tank 5011 can be further partially or fully enclosed in the second inner tank 5012. When the first inner tank 5011 is configured in the second inner tank (which is a heat exchanger), it would prevent some heat leakage.

While the invention has been described in terms of what are presently considered to be the most practical and preferred embodiments, it is to be understood that the invention need not be limited to the disclosed embodiments. On the contrary, it is intended to cover various modifications and similar arrangements included within the spirit and scope of the appended claims, which are to be accorded with the broadest interpretation so as to encompass all such modifications and similar structures. Therefore the above description and illustration should not be taken as limiting the scope of the present invention which is defined by the appended claims.

What is claimed is:

1) A solar hot water system, comprising:
a thermal storage tank holding a first fluid and comprising:
a first inlet inputting the first fluid;
a first outlet outputting the first fluid;
a first inner tank holding a second fluid, exchanging a heat between the first fluid and the second fluid and having a second inlet and a second outlet; and
a second inner tank having a first heater heating the first fluid, a third inlet connected to the first outlet and a third outlet outputting the heated first fluid;
a pump circulating the second fluid to flow through the second outlet and to the second inlet; and
a solar collector panel absorbing a solar energy provide at least a portion of the heat to the second fluid.

2) A solar hot water system as claimed in claim 1 further comprising a first temperature sensor detecting a first temperature of the first inner tank, a second temperature sensor detecting a second temperature of the solar collector panel and a pump controller controlling the pump according to the first and the second temperatures.

3) A solar hot water system as claimed in claim 1 further comprising a first pipe connected to the third inlet and the first outlet, a second pipe connected to the pump and the second outlet and a third pipe connected to the pump and the second inlet, wherein the first fluid is provided by an external source, the third pipe has a specific portion configured in the solar collector panel, the first heater is an electrical heating element, the thermal storage tank is an insulating tank, and each of the thermal storage tank, the first inner tank and the second inner tank has a bottom and a top.

4) A solar hot water system as claimed in claim 3, wherein the first inlet and the first outlet are respectively positioned near the bottom and the top of the thermal storage tank, the second inlet and the second outlet are respectively positioned near the top and the bottom of the first inner tank, and the third inlet and the third outlet are respectively positioned near the bottom and the top of the second inner tank.

5) A solar hot water system as claimed in claim 3, wherein the thermal storage tank further comprises at least one sacrificial anode retarding a corrosion and a second heater heating the first fluid, and the second inner tank is inside the first inner tank.

6) A solar hot water system as claimed in claim 3 further comprising a first heater controller having a third temperature sensor, adjusting an electrical current of the electrical heating element and regulating a third temperature of the heated first fluid.

7) A solar hot water system as claimed in claim 3, wherein the third pipe has a valve configured therein and holding the second fluid in the specific portion of the third pipe.

8) A solar hot water system as claimed in claim 1, wherein the thermal storage tank is a standard gas fired hot water heater being free from a burner and a temperature controller, and the standard gas fired hot water heater has a sealed top and a sealed bottom.

9) A hot water system, comprising:
a thermal storage tank holding a first fluid and comprising:
a first inlet inputting the first fluid;
a first outlet outputting the first fluid; and
a first inner tank having a first heater heating the first fluid, a second inlet connected to the first outlet and a second outlet outputting the heated first fluid.

10) A hot water system as claimed in claim 9, wherein the thermal storage tank further comprises a second inner tank holding a second fluid, exchanging a heat between the first fluid and the second fluid, and having a third inlet and a third outlet.

11) A solar water system as claimed in claim 10, further comprising:
a first pipe connecting the second inlet and the first outlet;
a pump circulating the second fluid;
a second pipe connecting the pump and the third outlet;
a heat collecting device;
a third pipe connecting the pump and the heat collecting device; and
a fourth pipe connecting the third inlet and the heat collector device.

12) A hot water system as claimed in claim 10, wherein the thermal storage tank is a standard gas fired hot water heater being free from a burner and a temperature controller, and the standard gas fired hot water heater has a sealed top and a sealed bottom.

13) A hot water system as claimed in claim 10, wherein the second inner tank has a specific configuration being one of a configuration partially enclosed in the first inner tank and a configuration fully enclosed in the first inner tank.

14) A method for controlling a hot water system having a pump, a heat collector and a first fluid, comprising the steps of:
(a) turning on the pump to circulate the first fluid and to provide the heat collector with the first fluid;
(b) turning off the pump after the pump is on for a first predetermined time to hold the first fluid in the heat collector;
(c) turning on the pump after the pump is off for a second predetermined time to circulate the first fluid again; and
(d) returning to the step (b).

15) A method as claimed in claim 14, wherein the step (a) further comprises the steps of:
(a1) turning on the pump when a first temperature of the heat collector is between a first predetermined temperature and a second predetermined temperature; and
(a2) turning off the pump when the first temperature is out of a range between the first predetermined temperature and the second predetermined temperature.

16) A method as claimed in claim 15, wherein the step (c) further comprises a step (c1) of turning off the pump when the first temperature is out of the range between the first predetermined temperature and the second predetermined temperature.

17) A method as claimed in claim 16, wherein the system further comprises a heat exchanging tank, the first fluid is circulated between the heat exchanging tank and the heat collector, and the second predetermined temperature is above the first predetermined temperature.

18) A method as claimed in claim 17, wherein the first predetermined temperature is above a second temperature of the heat exchanging tank.

19) A method as claimed in claim 17, wherein the step (a) further comprises a step (a3) of turning off the pump when the first temperature is below a second temperature of the heat exchanging tank, and the step (c) further comprises a step (c2) of turning off the pump when the first temperature is below the second temperature of the heat exchanging tank.

20) A method as claimed in claim 17, wherein the step (a2) further comprises a step of (a21) draining all the first fluid back to the heat exchanging tank when the pump is turned off and the step (c1) further comprises a step of (c11) draining all the first fluid back to the heat exchanging tank when the pump is turned off.

21) A method as claimed in claim 14, wherein the step (b) further comprises a step (b1) of turning off the pump when the heat collector is filled up with the first fluid.

22) A method as claimed in claim 14, wherein the step (c) further comprises a step (c1) of turning on the pump when a third temperature of the first fluid in the heat collector reaches a third predetermined temperature.
